(19) United States
(12) Patent Application Publication
(10) Pub. No.: US 2010/0142590 A1
(43) Pub. Date: Jun. 10, 2010

(54) CALIBRATION IN A SPREAD SPECTRUM COMMUNICATIONS SYSTEM

(76) Inventors: Thomas Höhne, Helsinki (FI); Gang Xu, Allen, TX (US)

Correspondence Address: Locke Lord Bissell & Liddell LLP;Attn: IP Docketing, Three World Financial Center, New York, NY, 10281-2101, US

(21) Appl. No.: 12/448,037

(22) PCT Filed: Dec. 8, 2006
(86) PCT No.: PCT/IB2006/004030

§ 371 Date: Jan. 4, 2010

(51) Int. Cl. H04B 1/707

(52) U.S. Cl. 375/141; 375/E01.002

(57) ABSTRACT

A method comprising: selecting an available orthogonal spreading code from a set of orthogonal spreading codes that are used for separating overlapping radio transmissions in a spread spectrum multiple access communication system; spreading a predetermined sequence using the selected spreading code; transmitting the spread predetermined sequence as a calibrating radio transmission; detecting a calibration signal corresponding to the calibrating radio transmission; and using the detected calibration signal to modify subsequent radio transmissions within the spread spectrum multiple access communication system.

### FIELD OF THE INVENTION

Embodiments of the present invention relate to calibration in a spread spectrum communications system. In particular, they relate to calibration of beam-forming in a spread spectrum communications system.

### BACKGROUND TO THE INVENTION

A beam forming antenna array comprises a plurality of antenna elements. Each antenna element is separately driven by a transmitter comprising for example a power amplifier and a mechanism for combining an RF carrier signal with an input baseband modulation signal.

The baseband signal provided to the each transmitter is modified to have a particular phase and amplitude offset so that the radio transmissions from the plurality of antenna elements add constructively and destructively to create a radiation pattern that extends predominantly in one direction more than another (a beam).

Additional unknown relative differences in phase and amplitude may be introduced by the use of separate transmitters and antenna arrays. These differences need to be compensated for if the beam forming antenna array is to be controlled accurately.

### BRIEF DESCRIPTION OF THE INVENTION

According to one embodiment of the invention there is provided a method comprising: selecting an available orthogonal spreading code from a set of orthogonal spreading codes that are used for separating overlapping radio transmissions in a spread spectrum multiple access communication system; spreading a predetermined sequence using the selected spreading code; transmitting the spread predetermined sequence as a calibrating radio transmission; detecting a calibration signal corresponding to the calibrating radio transmission; and using the detected calibration signal to modify subsequent radio transmissions within the spread spectrum multiple access communication system.

According to another embodiment of the invention there is provided an apparatus comprising: a code controller for assigning codes to at least a first antenna element that is operable to assign an orthogonal spreading code from a set of orthogonal spreading codes, which are used for separating overlapping radio transmissions in a spread spectrum multiple access communication system, to a first antenna element; a first combiner for combining an input signal with an assigned code to create, as output, a spread input signal; a memory storing a predetermined sequence; a controller for controlling the code controller to assign an available spreading code to the first antenna element and to provide the predetermined sequence as the input signal to the first combiner; a first transmitter for converting a spread predetermined sequence output by the first combiner to a calibrating radio transmission of the first antenna element; a first detector for detecting a calibration signal corresponding to the calibrating radio transmission; and a filter for using a result of processing the detected calibration signal to modify subsequent radio transmissions of the first antenna element.

According to a further embodiment of the invention there is provided a method of controlling calibration of a beam-forming antenna array having N elements that is operable in a spread spectrum multiple access communications system that provides multiple access using a set of orthogonal spreading codes, comprising: controlling the timing of the calibration process in dependence upon the allocation of the set of orthogonal spreading codes for multiple access communication, wherein the calibration process only occurs when there are at least N members of the set of orthogonal spreading codes that are not used for multiple access communications.

According to another embodiment of the invention there is provided a computer program comprising computer program for controlling timing of the calibration process in dependence upon allocation of a set of orthogonal spreading codes for multiple access communication, wherein the calibration process only occurs when there are at least N members of the set of orthogonal spreading codes that are not used for multiple access communications.

According to a further embodiment of the invention there is provided a method of generating calibrating radio transmissions for calibrating a beam forming antenna array having N elements that is operable in a spread spectrum multiple access communications system that provides multiple access using a set of orthogonal spreading codes, comprising: spreading a common predetermined sequence that is not intended for reception using N orthogonal spreading codes to create a differently spread common predetermined sequence for each of the antenna elements; and transmitting, in overlap, the spread common predetermined sequences.

According to another embodiment of the invention there is provided a method comprising: using a communication channel of a spread spectrum multiple access communication system when it is not being used to transfer information between a base station and a terminal to transmit a predetermined beam-forming array calibration sequence.

According to a further embodiment of the invention there is provided a computer program comprising computer program instructions for enabling use of a communication channel of a spread spectrum multiple access communication system when it is not being used to transfer information between a base station and a terminal to transmit a predetermined beam-forming array calibration sequence.

According to another embodiment of the invention there is provided a method comprising: associating each of a plurality of communication channels of a spread spectrum multiple access communication system, when they are not being used to transfer information between a base station and terminals, with one of a plurality of beam-forming antenna elements; and simultaneously transmitting a predetermined calibration sequence from each of a plurality of beam-forming antenna elements, wherein the predetermined calibration sequence transmitted by an antenna element is spread using an orthogonal spreading code of the communication channel associated with that antenna element.

Embodiments of the invention have a number of advantages.

Embodiments that re-use only available orthogonal spreading codes for data transmission when calibrating avoid or reduce interference with data transmissions.

The avoidance or reduction of interferences allows calibration to occur at a base station while it is in-situ and in-use. There is no need to take the base station off-line.

The avoidance or reduction of interferences allows calibration to occur at higher power levels. This allows accurate calibration to be achieved in shorter time periods.

The avoidance of mutual interference between the antenna elements while calibrating allows the calibration of each transmission branch to occur in parallel. This improves accuracy and enables compensation of phase drift that is common to the transmission branches.

Embodiments of the invention that reuse the orthogonal codes for data transmission when calibrating, allow functional components of the system that are used for data communication to be re-used for calibration.

### BRIEF DESCRIPTION OF THE DRAWINGS

For a better understanding of the present invention reference will now be made by way of example only to the accompanying drawings in which:

FIG. 1 schematically illustrates a macrocellular spread spectrum multiple access communications system 10;

FIG. 2 schematically illustrates a base station having a beam-forming antenna array;

FIGS. 3 and 4 illustrate a calibration process; and

FIG. 5 schematically illustrates a computer system for performing or enabling the calibration process.

### DETAILED DESCRIPTION OF EMBODIMENTS OF THE INVENTION

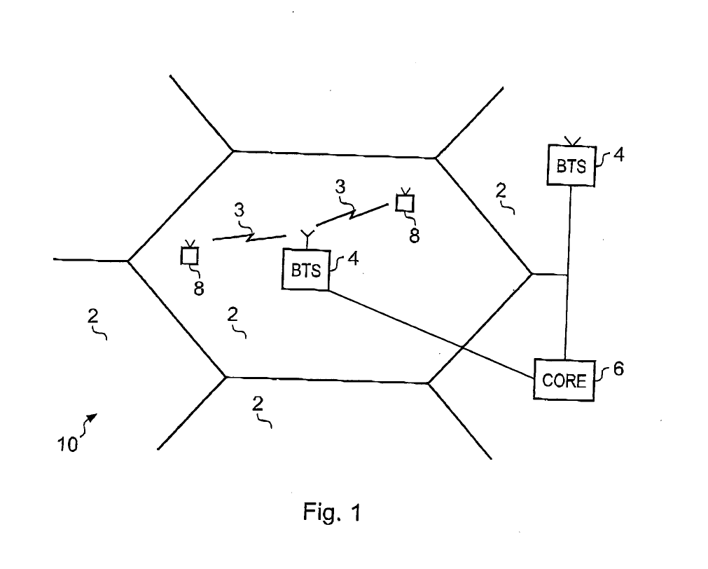

FIG. 1 schematically illustrates a macrocellular spread spectrum multiple access communications system 10. The system 10 comprises a plurality of cells 2, each of which has a base station 4. The base stations are controlled by core network controller 6, which typically includes a switching centre. Terminals 8 in a cell 2 communicate with the serving base station 4 of that cell 2 using the radio frequency transmissions 3.

The system 10 uses a set of orthogonal spreading codes. Different orthogonal codes are used to define different communication channels for transmitting data, which may be control data and/or user data. As a result the orthogonal codes may be referred to as channelization codes. The channelization codes separate overlapping transmissions that share the same time and same frequency space.

The cross-correlation between orthogonal spreading codes is zero for synchronous transmission i.e. there is orthogonality for zero delay.

Data for transmission to a particular terminal is spread using an assigned orthogonal code so that it is transferred as radio transmissions in its own channel. Data for transmission from a particular terminal is spread using an assigned orthogonal code so that it is transferred as radio transmissions in its own channel.

In IS-95 and its derivatives such as CDMA2000, Walsh codes are used as orthogonal spreading codes.

In UMTS/WCDMA , tree structured orthogonal codes, such as Orthogonal Variable Spreading Factor (OVSF) codes, are used as orthogonal spreading codes.

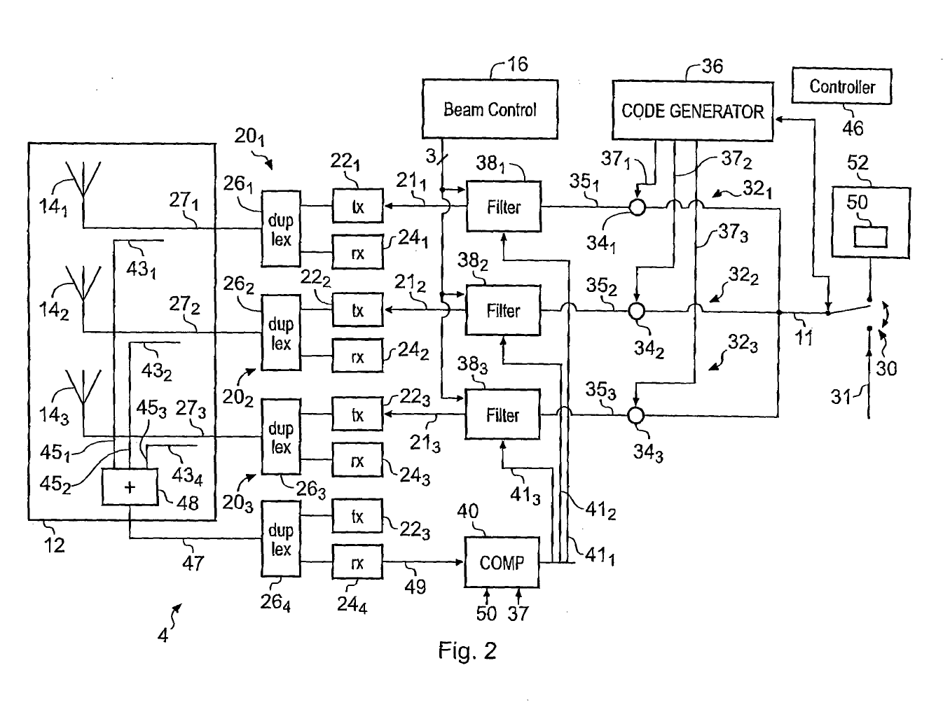

Referring to FIG. 2, the base station 4 comprises a beam-forming antenna array 12 comprising a plurality of antenna elements 14ᵢ, where i=1, 2, . . . N. When a beam is formed for communication of a signal to a terminal, the signal with different applied variations in phase and amplitude is applied to each of the N antenna elements 14ᵢ. The variations in phase and amplitude are controlled by a beam controller 16 so that constructive and destructive interference of the mutually overlapping antenna element radiation patterns form a directed radiation pattern (a beam).

Each antenna element 14ᵢ has connected to it an associated transceiver 20ᵢ. A transceiver 20ᵢ comprises a transmitter 22ᵢ, a receiver 24ᵢ and a duplexer 26ᵢ for isolating the receiver 24ᵢ from the transmitter 22ᵢ.

Each of the transmitters 22ᵢ is arranged to modulate an RF carrier frequency using a respective input baseband signal 21ᵢ to create radio transmissions 27ᵢ.

The base station 4 has two modes of operation—a normal mode and a calibration mode. The transition between these modes is schematically illustrated in the Figure by switch 30. When the switch 30 is ‘up’ the base station 4 is in the calibration mode and when the switch 30 is down the base station 4 is in the normal mode.

In the normal mode of operation, data 31 comprising control and/or user data, is processed simultaneously through N separate branches 32 to create respective N baseband signals 21.

In each branch 32ᵢ, the data signal 11, comprising data 31, is combined at a combiner 34ᵢ with an orthogonal code 37 provided by the code controller 36 to form a spread signal 35. In the normal mode the same orthogonal code is provided to each of the N combiners 34 in the N branches 32.

The N spread signals 35 are then provided to N respective filters 38. A filter 38ᵢ adds a phase delay/advance to the spread signal 35ᵢ and amplitude gain to the spread signal 35ᵢ.

The magnitude of the phase delay/advance and amplitude gain are controlled by a beam controller 16 and also by compensation circuitry 40. As described previously, the beam controller 16 controls the N filters 38 to introduce relative phase and amplitude differences into the baseband signals 21 so that the N baseband signals 21 produced by the filters 38 produce, from the N antenna elements, a radiation beam. The compensation circuitry 40 provides for phase and amplitude adjustments to compensate for the difference between the expected radiation beam and the actual radiation beam.

The transmitters 22 and the ‘transmitter chain’ or branch 32 include many components that may introduce time variable artefacts or noise into the radio transmissions 27 so that the actual radiation beam formed is not the expected radiation beam. The compensation circuitry 40 compensates for the artefacts introduced by the transmitter or transmitter chain. A separate correction factor 41 is determined for each of the filters 38. A correction factor 41 provides the phase and amplitude adjustment values that are required to compensate the baseband signal 21 produced by a filter 38.

In the calibration mode of operation the correction factors 41 used in the normal mode of operation are determined.

A predetermined training sequence 50 which is stored in memory 52 is provided by the switch 30 for simultaneous processing through the N branches 32 to create respective N baseband signals 21. The sequence is predetermined in the sense that it has prior existence and is not contemporaneously generated. It may therefore be repeatedly re-used.

The training sequence 50 is arranged to have good auto-correlation properties as the original training sequence will, as described below, be cross-correlated with detected training sequences.

In each branch 32ᵢ, the predetermined training sequence 50 is combined at a combiner 34ᵢ with an orthogonal code 37ᵢ provided by the code controller 36 to form a spread signal 35ᵢ. In the calibration mode, different orthogonal codes 37ᵢ are provided to each of the combiners 34ᵢ in the N branches.

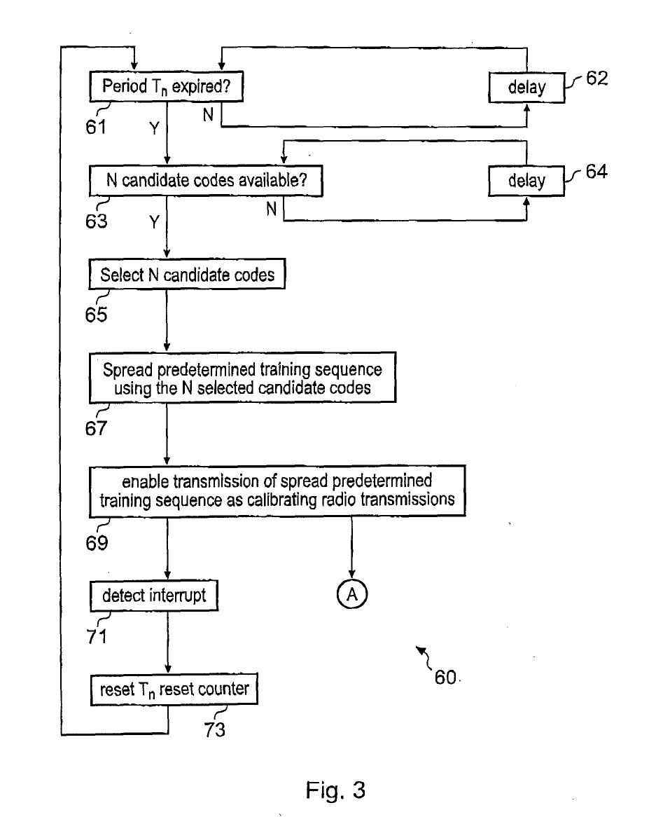

The set of orthogonal codes used in the normal mode of operation are re-used in the calibration mode of operation. That is the orthogonal codes used for data transmission are also used for spreading the calibration training sequence. The generation of candidate orthogonal spreading codes is described in more detail in relation to FIG. 3.

The N spread predetermined training sequences 35 are then provided to respective N filters 38. A filter 38 adds a phase delay/advance and amplitude gain to the spread predetermined training sequence 35.

The magnitude of the phase delay/advance and amplitude gain are controlled by a beam controller 16 and also by compensation circuitry 40. As described previously, the beam controller 16 controls the filters 38 of the different branches to introduce relative phase and amplitude differences into the baseband signals 21. The compensation circuitry 40, depending upon implementation of the calibration mode either provides for phase and amplitude adjustments to compensate for the difference between the expected radiation beam and the actual radiation beam or provides no compensation. In the first implementation, the calibration procedure determines corrections to the phase and amplitude adjustments. In the second implementation, the calibration procedure recalculates the phase and amplitude adjustments.

A controller 46 controls the mode of the device. When the mode is changed, it toggles the switch 30 and informs the code generator 36.

The calibration process 60 is illustrated in FIG. 3. The process is illustrated as a series of blocks. These blocks may be steps in a method or some may be code portion in a computer program 80.

At block 61, it is determined at controller 46 whether a period Tn has expired since a counter was last re-set.

If the period Tn has not expired, the process returns to block 60 after a delay 62.

If the period Tn has expired the process moves to block 63.

At block 63, it is determined by controller 46 whether N candidate orthogonal codes are available. The controller 46 has knowledge of which orthogonal codes in the set of orthogonal codes are currently assigned to data transmission. It therefore also has knowledge of which orthogonal codes are unassigned.

If OVSF codes or other codes derived from a code tree are used, then a further condition may be added to the requirement for a code in the set of codes to be a candidate. In a code tree, the use of a code with a spreading factor M typically prevents the use of codes that depend from that code. The use of a code with a spreading factor M in a tree of size S may consequently prevent the use of 2^{S-M} codes. It is therefore desirable for the further condition to require that a candidate code has a specified position within the code tree, such as for example, having a spreading factor greater than a threshold value or having the maximum available spreading factor.

If the correct number of candidate orthogonal codes are not available, the process returns to block 63 after a delay 64.

If the correct number of candidate orthogonal codes are available, the process moves to block 65.

At block 65, N orthogonal spreading codes are selected from the candidate codes and each of the selected N candidate codes 37ᵢ is associated with a respective one of the N antenna elements 14ᵢ.

Next at block 67, the predetermined training sequence 50 is separately spread using the N selected candidate orthogonal codes 37ᵢ to form N spread predetermined sequences 35ᵢ. The spread predetermined training sequences 35 may or may not be filtered.

Next at block 69, simultaneous transmission of the N spread predetermined training sequences 35ᵢ starts and continues until an interrupt is detected at block 71. The predetermined data sequence is transmitted for calibration of the transmitters 22 or transmitter chains and not for reception by a terminal.

The interrupt may be internally generated, for example, because the transmission of the N spread predetermined sequences 35 has been continuing for more than a set threshold value. Alternatively, the interrupt may be externally generated. The core network controller 6 typically assigns codes to data communication channels so that interference between adjacent cells is minimised. The core network controller 6 informs the base station controller 46 of the assignment of codes in its cell. If there is a conflict between the assignment of an orthogonal code by the core network controller 6 to data transmission and the selection of a candidate orthogonal code by the base station 2 for antenna array calibration, then the core network controller assignment prevails. Consequently an interrupt may be generated when the core network controller assigns one of the selected candidate codes that is being used to spread one of the transmitted predetermined sequences.

After detecting an interrupt, the transmission of the spread predetermined sequences stops and, at block 73, the counter is reset and the value Tn may be recalculated. The value Tn may in some embodiments be fixed. In other embodiments it varies. For example, it may be varied in dependence upon the time period for which the spread predetermined codes were transmitted—the longer the time period of transmission the larger Tn.

The calibration process 60 also includes a feedback detection and analysis process as illustrated in FIG. 4. The process is illustrated as a series of blocks. These blocks may be steps in a method or some may be code portion in a computer program 80. The process is initiated from block 69 of FIG. 3.

Referring to FIGS. 2 and 4, at block 90, the radio transmissions 27ᵢ are detected as they are fed to the respective antenna elements 14ᵢ. Each of the feeds has an associated RF coupler 43ᵢ that couples a proportion of the RF signal on the feed to form a calibration signal 45ᵢ. The calibration signal 45ᵢ for an antenna element 14ᵢ thus corresponds to the contemporaneous radio transmissions of that antenna element. The detected calibration signal 45ᵢ for an antenna element is used to modify subsequent radio transmissions 27ᵢ by that antenna element 14ᵢ within the spread spectrum multiple access communication system.

The calibration signals 45ᵢ for the antenna elements 14ᵢ are each inherently spread by a different one of the selected orthogonal codes 37ᵢ. They can therefore be combined at combiner 48 without mutual interference before being received by a receiver as received signal 47.

The receiver obtains reception baseband signal 49 from the received signal 47. At block 92, the baseband signal 49 is then separately despread by compensation circuitry 40 using each of the selected orthogonal codes 37ᵢ to create N baseband signals each of which is associated with a different antenna element 14ᵢ.

At block 94, each of the N baseband signals is then in this example cross correlated with the predetermined training sequence 50 to determine the impulse response (IRᵢ) of the transmitter (transmitter chain) 22ᵢ that provides radio transmissions 27ᵢ to the associated antenna element 14ᵢ. The predetermined data sequence is thus used as a calibrating reference for the transmitters (transmitter chains).

At block 96, the impulse response (IRᵢ) is used by compensation circuitry 40 to create the correction factor 41ᵢ for the filter 38ᵢ that filters the baseband signal 21ᵢ input to the transmitter (transmitter chain) 22ᵢ that provides radio transmissions 27ᵢ to the associated antenna element 14ᵢ.

A filter 38 may be one tap filter and the correction factor 41 may be an amplitude value and a phase value.

Although a particular correlation procedure for obtaining correction factors has been described, other procedures may be used and the invention should not be considered to be limited to the use of a training sequence and cross-correlation.

At block 96, the newly determined correction factors 41ᵢ for each of the branches 32ᵢ are uploaded to the respective filters 38ᵢ to filter future transmission baseband signals 21ᵢ and consequently control future radio transmissions 27ᵢ.

In the event of an interrupt, the partial correlation results obtained thus far may be used to estimate correction factors 41 which are then used. The use of the estimated correction factors may be conditional. For example, they may only be used if there is sufficient confidence in the accuracy of the estimated correction factors.

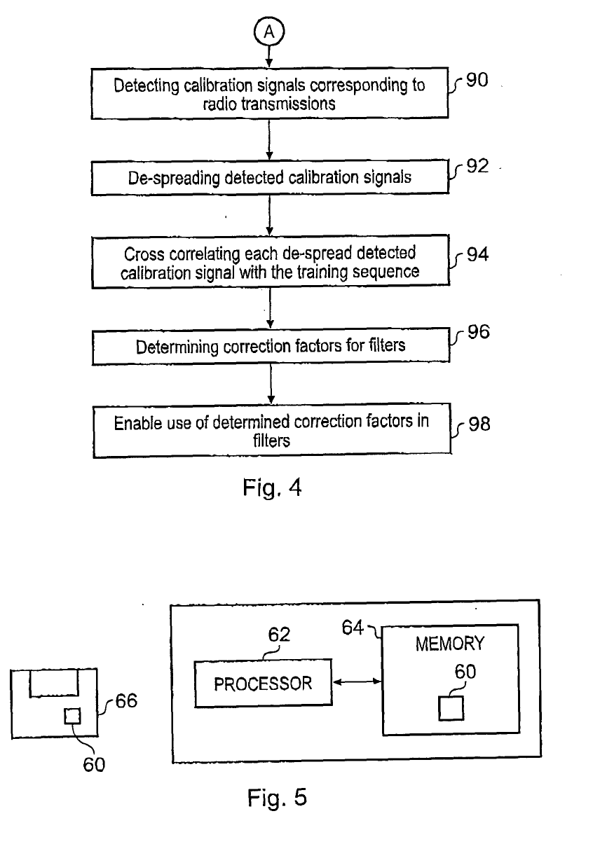

FIG. 2 schematically illustrates a number of functional blocks some of which may be performed by a processor 62 that is controlled by a computer program 60 stored in memory 64 as illustrated in FIG. 5. For example some or all of the blocks in FIGS. 3 and 4 may be performed or enabled by a digital signal processor implemented as dedicated hardware or a programmable processor.

The memory 64 stores computer program instructions 60 that control the operation of such a processor 62. The computer program instructions 60 provide the logic and routines that enables the processor 62 to perform or enable the methods illustrated in FIGS. 3 and 4.

The computer program instructions may arrive at the memory 64 via an electromagnetic carrier signal or be copied from a physical entity 66 such as a computer program product, a memory device or a record medium such as a CD-ROM or DVD.

In the embodiments described above, the detection of the radio transmissions 27 are ‘downlink’ radio transmissions made by the base station. The calibration process therefore compensates for variations of the base station transmitters (transmitter chains) from ideal but does not compensate for variations of the antenna elements from ideal.

In other embodiments, as an alternative to detection at the base station or in addition to detection at the base station, detection may occur at a remote mobile terminal i.e. over-the-air detection. The calibration signals may then be returned to the base station for processing or, possibly, processing could occur at the mobile terminal with the results of the processing being returned to the base station. However, the calibration signal detected at the mobile terminal will have been influenced not only by the impulse responses of the base station transmitter (transmitter chain) and antenna elements but also by the impulse response of the radio communications channel, the mobile terminal's antenna element and receiver (or receiver chain). Consequently additional processing is required to remove at least the impulse response of the radio communications channel which particularly for cdma communications systems may vary significantly with time.

Although embodiments of the present invention have been described in the preceding paragraphs with reference to various examples, it should be appreciated that modifications to the examples given can be made without departing from the scope of the invention as claimed. For example, although the beam forming antenna array is described as a component in a base station, it should be appreciated that a beam forming system 10 may be used in any radio communications device including mobile terminal, satellites, relays etc. For example, although the preceding description describes the use of a common predetermined training sequence for each of the branches 32, it should be understood that different references may be used for each of the branches 32.

In the preceding calibration example, the N antenna elements 14 are calibrated simultaneously in parallel using N different selected orthogonal spreading codes.

In another implementation, the N antenna elements may be calibrated in groups of size M, where M=2, 3 . . . or N, using M different selected orthogonal spreading codes. In this implementation, each of the M antennas in a group are calibrated simultaneously but the groups are calibrated separately, perhaps sequentially.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1. A method comprising:
selecting first and second available orthogonal spreading codes from a set of orthogonal spreading codes that are used for separating overlapping radio transmissions in a spread spectrum multiple access communication system;
spreading a predetermined sequence using the selected first spreading code to create a first spread predetermined sequence;
spreading the predetermined sequence using the selected second spreading code to create a second spread predetermined sequence;
simultaneously transmitting from a first antenna element the first spread predetermined sequence as a first calibrating radio transmission and transmitting from a second different antenna element the second spread predetermined sequence as a second calibrating radio transmission;
detecting a first calibration signal corresponding to the first calibrating radio transmission and a second calibration signal corresponding to the second calibrating radio transmission; and
using the detected first and second calibration signals to modify subsequent radio transmissions within the spread spectrum multiple access communication system.

2. A method as claimed in claim 1, comprising:
selecting N available orthogonal spreading codes from the set of orthogonal spreading codes where N is greater than two;
associating each of the selected N available orthogonal spreading codes with a respective one of N antenna elements; and
transmitting from each of the N antenna elements N respective calibrating radio transmissions, wherein a calibrating radio transmission transmitted by an antenna element is a predetermined data sequence that has been spread using the antenna element's associated orthogonal spreading code.

3. A method as claimed in claim 2, wherein the N calibrating radio signals are simultaneously transmitted.

4. A method as claimed in claim 2, wherein the N antenna elements are controlled to provide a beam-forming antenna array.

5. A method as claimed in claim 1, wherein a radio transmission comprises an RF carrier modulated by a modulation signal that has been created by: spreading using a member of the set of orthogonal codes; and filtering, to modify the radio transmission, using a filter dependent upon a previously detected calibration signal.

6. A method as claimed in claim 1, wherein at least some of the orthogonal spreading codes of the set of orthogonal spreading codes are unavailable because they are being used to spread data transmitted to/from terminals of the spread spectrum multiple access communication system and wherein the selected orthogonal spreading codes will, in future, be unavailable because they will be used to spread data transmitted to/from terminals of the spread spectrum multiple access communication system.

7. A method as claimed in claim 1 wherein using a detected calibration signal to modify subsequent radio transmissions comprises:
de-spreading the detected calibration signal and cross-correlating the despread calibration signal with the predetermined sequence to determine information for modifying subsequent radio transmissions.

8. A method as claimed in claim 7, wherein the result of the cross correlation is used to determine an amplitude filter value and a phase filter value for modifying subsequent radio transmissions within the spread spectrum multiple access communication system.

9. A method as claimed in claim 1, further comprising interrupting the method if a selected orthogonal spreading code is allocated for multiple access communication.

10. A method as claimed in claim 1, further comprising controlling the timing of the initiation of the method in dependence upon the allocation of the set of orthogonal spreading codes for multiple access communication, wherein the method only occurs when there are simultaneously available at least N members of the set of orthogonal spreading codes that are not used for multiple access communications.

11. An apparatus comprising:
a code controller configured to assign first and second orthogonal spreading codes from a set of orthogonal spreading codes that are used for separating overlapping radio transmissions in a spread spectrum multiple access communication system, to respective antenna elements;
a first combiner for combining a first input signal with the assigned first code to create, as output, a first spread input signal;
a second combiner for combining a second input signal with the assigned second code to create, as output, a second spread input signal;
a memory storing a predetermined sequence;
a controller configured to control the code controller to assign a first available spreading code to a first antenna element and to control the code controller to assign a second available spreading code to a second antenna element and configured to provide the predetermined sequence simultaneously as the first input signal to the first combiner and as the second input signal to the second combiner and;
a first transmitter configured to convert a spread predetermined sequence output by the first combiner to a first calibrating radio transmission of the first antenna element;
a first detector configured to detect a first calibration signal corresponding to the first calibrating radio transmission;
a second transmitter configured to convert a spread predetermined sequence output by the second combiner to a second calibrating radio transmission of the second antenna element;
a second detector configured to detect a second calibration signal corresponding to the second calibrating radio transmission;
a first filter configured to use a result of processing the first detected calibration signal to modify subsequent radio transmissions of the first antenna element; and
a second filter configured to use a result of processing the second detected calibration signal to modify subsequent radio transmissions of the second antenna element.

12. An apparatus as claimed in claim 11, wherein the code controller is operable to assign N available orthogonal spreading code from a set of orthogonal spreading codes to N antenna elements where N is greater than two.

13. An apparatus as claimed in claim 12, further comprising at least N combiners, each of which is arranged to combine the predetermined sequence with a different one of the N assigned codes to create, as output, a spread input signal; and N transmitters for converting the N spread predetermined sequences output by the N combiners to N calibrating radio transmissions of the N antenna elements.

14. An apparatus as claimed in claim 13 further comprising N detectors for detecting the N calibration signals corresponding to the N calibrating radio transmissions.

15. An apparatus as claimed in claim 14 further comprising N filters for using N results of processing the N detected calibration signal to modify subsequent radio transmissions of the N antenna elements.

16. An apparatus as claimed in claim 12, further comprising means for controlling the N antenna elements to provide a beam-forming antenna array.

17. An apparatus as claimed in claim 11, wherein the code controller is configured to re-assign an assigned orthogonal spreading code if that orthogonal spreading code is required for multiple access communication.

18. A method of controlling calibration of a beam-forming antenna array having N elements that is operable in a spread spectrum multiple access communications system that provides multiple access using a set of orthogonal spreading codes, comprising:
controlling the timing of the calibration process in dependence upon the allocation of the set of orthogonal spreading codes for multiple access communication, wherein the calibration process only occurs when there are simultaneously available at least N members of the set of orthogonal spreading codes that are not used for multiple access communications.

19. A computer readable medium comprising computer program instructions that when executed by a computer causes the computer to control timing of the calibration process in dependence upon allocation of a set of orthogonal spreading codes for multiple access communication, wherein the calibration process only occurs when there are simultaneously available at least N members of the set of orthogonal spreading codes that are not used for multiple access communications.

20. (canceled)

21. (canceled)

22. (canceled)

23. A method comprising:
associating each of a plurality of communication channels of a spread spectrum multiple access communication system, when they are not being used to transfer information between a base station and terminals, with one of a plurality of beam-forming antenna elements; and
simultaneously transmitting a predetermined calibration sequence from each of a plurality of beam-forming antenna elements, wherein the predetermined calibration sequence transmitted by an antenna element is spread using an orthogonal spreading code of the communication channel associated with that antenna element.
